(19) United States
(12) Patent Application Publication
(10) Pub. No.: US 2024/0086695 A1
(43) Pub. Date: Mar. 14, 2024

(54) DRIVING WORLD MODEL BASED ON BRAIN-LIKE NEURAL CIRCUIT

(71) Applicant: TONGJI UNIVERSITY, Shanghai (CN)

(72) Inventors: Yanjun HUANG, Shanghai (CN); Jiatong DU, Shanghai (CN); Yulong BAI, Shanghai (CN); Hong CHEN, Shanghai (CN)

(21) Appl. No.: 18/511,730

(22) Filed: Nov. 16, 2023

(30) Foreign Application Priority Data
Sep. 13, 2023 (CN) 202311179915.9

(51) Int. Cl. G06N 3/063; G06V 10/82

(52) U.S. Cl. CPC G06N 3/063; G06V 10/82

(57) ABSTRACT

The present application relates to the technical field of vehicle control, and in particular, to a driving world model based on a brain-like neural circuit. The driving world model includes: a perception module, an environment memory module, a brain-like neural circuit network module, and a convolutional network module; the perception module includes a two-dimensional feature encoding unit, a three-dimensional feature encoding unit, a summing pooling unit which are connected in sequence; the environment memory module is configured to acquire a current moment and memorize environment dynamics information; the brain-like neural circuit network module is configured to establish a brain-like neural circuit network. The present application uses a monocular camera image as an input image. The world model is applied to extracting and memorizing environment dynamics information, simulating a nematode nervous system to establish the brain-like neural circuit to process the environment dynamics information, completing an end-to-end automatic driving task.

### CROSS-REFERENCE TO RELATED APPLICATIONS

This application claims the benefit of priority from Chinese Patent Application No. 202311179915.9, filed on Sep. 13, 2023. The content of the aforementioned application, including any intervening amendments thereto, is incorporated herein by reference in its entirety.

### TECHNICAL FIELD

Embodiments of the present application relates to the technical field of vehicle control, and in particular, to a driving world model based on a brain-like neural circuit.

### BACKGROUND OF THE INVENTION

Nowadays, artificial intelligence is being transitioned from proprietary artificial intelligence to general artificial intelligence, and a generative large model represented by ChatGPT shows extraordinary talents in the field of natural language processing, and becomes an existing mainstream general artificial intelligence model for natural language processing. Automatic driving is a reflection of cross fusion of the automobile industry and a new-generation information technology such as artificial intelligence, automatic control, and big data in the traffic field. A high-grade automatic driving system needs to cope with almost all complex traffic environments and complete driving tasks safely and efficiently.

However, most of existing automatic driving models use a modularization method. The method requires a large amount of artificial engineering and involves manual annotation of a single module and cross-module configuration. A new environment and a new task need to be manually redesigned for algorithm upgrade, so that the method is poor in mobility and cannot adapt to development and requirements of the general artificial intelligence.

### SUMMARY

The embodiments of the present application provide a driving world model based on a brain-like neural circuit. The model uses a monocular camera image as an input. The world model is applied to extracting and memorizing environment dynamics information, simulating a nematode nervous system to establish the brain-like neural circuit to process the environment dynamics information, and completing an end-to-end automatic driving task.

In order to solve the above technical problem, an embodiment of the present application provides a driving world model based on a brain-like neural circuit. The driving world model includes a perception module, an environment memory module, a brain-like neural circuit network module, and a convolutional network module, wherein the perception module is configured to perform image encoding on an input image by taking a monocular camera image as the input image and acquire an image feature under a view angle of an aerial view; the perception module includes a two-dimensional feature encoding unit, a three-dimensional feature encoding unit, and a summing pooling unit which are connected in sequence; the two-dimensional feature encoding unit is configured to extract two-dimensional features from the image feature; the three-dimensional feature encoding unit is configured to project the two-dimensional features to a three-dimensional space to obtain three-dimensional features and predicting a depth probability distribution of each three-dimensional feature; the summing pooling unit is configured to map the three-dimensional features to a bird's eye view space in a summing pooling manner according to the depth probability distributions to obtain the image feature under the view angle of the aerial view; the environment memory module is configured to: acquire environment dynamics information of a current moment according to the image feature and a hidden feature, and output the environment dynamics information to the brain-like neural circuit network module and the convolutional network module; the brain-like neural circuit network module is configured to: simulate a nematode neural network, establish a brain-like neural circuit network, and input the environment dynamics information to the brain-like neural circuit network to obtain a control output of automatic driving; and the convolutional network module is configured to input the environment dynamics information to a convolutional network to generate a bird's eye view of an environment.

In some exemplary embodiments, the environment memory module includes a posterior distribution fitting unit, a prior distribution fitting unit, and a training unit, wherein the posterior distribution fitting unit is configured to fit an environment dynamics posterior distribution through the image feature; the prior distribution fitting unit is configured to fit an environment dynamics prior distribution through the hidden feature; and the training unit is configured to: perform training using a minimum difference between the environment dynamics posterior distribution and the environment dynamics prior distribution, obtain environment dynamics information of a current moment on the basis of the environment dynamics posterior distribution and the hidden feature, and generate a hidden feature of the current moment by using the environment dynamics information of the current moment as a hidden feature of a next moment.

In some exemplary embodiments, the environment memory module acquires the environment dynamics information of the current moment by respectively generating a posterior feature and a prior feature according to the image feature and the hidden feature, wherein the posterior feature is generated by sampling a hidden feature containing historical moment information, an action of a previous moment, and the image feature; and the prior feature is generated by sampling the hidden feature containing the historical moment information and the action of the previous moment.

In some exemplary embodiments, assuming that the posterior feature and the prior feature are both in accordance with a normal distribution, and generation processes of the posterior feature and the prior feature are expressed as:

$$\{ \begin{matrix}{x}_{k} = {f}_{e} ( {o}_{k} ) \\ q ( {s}_{k} ) ∼ N ( {μ}_{θ} ( {h}_{k} , {a}_{k - 1} , {x}_{k} ) , {σ}_{θ} ( {h}_{k} , {a}_{k - 1} , {x}_{k} ) ) \\ p ( {z}_{k} ) ∼ N ( {μ}_{φ} ( {h}_{k} , {a}_{k - 1} ) , {σ}_{φ} ( {h}_{k} , {a}_{k - 1} ) ) \\ {h}_{k + 1} = {f}_{ϕ} ( {h}_{k} , {s}_{k} )\end{matrix} \qquad ( 1 )$$

wherein xₖ represents the image feature; oₖ represents an input image; sₖ represents the posterior feature; Zₖ represents the prior feature; hₖ represents the hidden feature; Xₖ=fₑ(oₖ) represents a process of obtaining the image feature by taking a monocular camera image at a moment k as an input; q(sₖ)˜N(μ_{θ}(hₖ, aₖ₋₁, xₖ), σ_{θ}(hₖ, aₖ₋₁, xₖ)) represents the generation process of the posterior feature; p(zₖ)˜N(μ_{φ}, aₖ₋₁), σ_{θ}(hₖ, aₖ₋₁)) represents the generation process of the prior feature; aₖ₋₁ represents the action of the previous moment; and hₖ₊₁=f_{ϕ}(hₖ, sₖ) represents that the hidden feature of the next moment is obtained through a recurrent neural network.

In some exemplary embodiments, at a future moment, generation processes of the prior feature and the hidden feature of the next moment are expressed as:

$$\{ \begin{matrix}p ( {z}_{k} ) \sim N ( {μ}_{φ} ( {h}_{k} , {a}_{k - 1} ) , {σ}_{φ} ( {h}_{k} , {a}_{k - 1} ) ) \\ {h}_{k + T + 1} = {f}_{ϕ} ( {h}_{k + T} , {z}_{k + T} )\end{matrix} \qquad ( 2 )$$

wherein p(zₖ)˜N (μ_{φ}(hₖ, aₖ₋₁), σ_{φ}(hₖ, aₖ₋₁)) represents the generation process of a prior feature of the future moment; aₖ₋₁ represents the action of the previous moment; h_{k+T} and z_{k+T} respectively represent a hidden feature and a prior feature of the future moment k+T ; and h_{k+T+1}=f_{ϕ}(h_{k+T}, z_{k+T}) represents a process of generating the hidden feature of the next moment using the hidden feature h_{k+T} and the prior feature z_{k+T} at the future moment k+T.

In some exemplary embodiments, the brain-like neural circuit network includes four layers of neurons, wherein the four layers of neurons respectively include: Nₛ perception neurons, Nᵢ internal neurons, N_{c} instruction neurons, and Nₘ motoneurons; nₛₒ₋ₜ synapses are inserted between any two successive layers for any source neuron, wherein nₛₒ₋ₜ satisfies nₛₒ₋ₜ≤Nₜ; a synapse polarity satisfies the Bernoulli distribution, wherein Nₜ represents a quantity of target neurons, and nₛₒ₋ₜ target neurons are randomly selected through binomial distribution; mₛₒ₋ₜ synapses are inserted between any two consecutive layers for any target neuron j without synapses; mₛₒ₋ₜ satisfies

$${m}_{so - t} \leq \frac{1}{{N}_{t}} {Σ}_{i = 1 , i \neq j}^{{N}_{t}} {L}_{{t}_{i}} ,$$

wherein Lₜ_{ᵢ} represents a quantity of target neurons i inserted with the synapses; a synapse polarity satisfies the Bernoulli distribution, and mₛₒ₋ₜ source neurons are randomly selected through binomial distribution; the instruction neurons are cyclically connected; lₛₒ₋ₜ synapses are inserted into any instruction neuron, wherein lₛₒ₋ₜ satisfies lₛₒ₋ₜ≤N_{c}; a synaptic polarity satisfies the Bernoulli distribution, wherein N_{c}represents a quantity of instruction neurons; and lₛₒ₋ₜ source neurons are randomly selected through binomial distribution.

In some exemplary embodiments, each neuron is modeled as follows according to features of current transmission between the synapses of the neuron:

$$\frac{dx ( t )}{dt} = - \frac{x ( t )}{τ} + {f}_{I} ( I ( t ) ) ( A - x ( t ) ) \qquad ( 3 )$$

wherein x(t) represents a current of the synapse of the neuron; l(t) represents an external input of the synapse; A represents deviation matrix; fₗ represents a neural network; and τ represents a time constant.

In some exemplary embodiments, the brain-like neural circuit network module includes a conversion unit; the conversion unit is configured to convert the environment dynamics information into control action information by using the brain-like neural circuit network, so as to achieve a conversion process from perception to control; a function g is used to represent the brain-like neural circuit network, and the conversion process is expressed by the following formulas:

$$\{ \begin{matrix}{a}_{k} = g ( {h}_{k} , {s}_{k} ) , a historical moment \\ {a}_{k + T} = g ( {h}_{k + T} , {z}_{k + T} ) , future moment\end{matrix} \qquad ( 4 )$$

wherein aₖ represents an action of the historical moment; hₖ represents the hidden feature; sₖ represents the posterior feature; a_{k+T} represents an action of the future moment; h_{k+T} represents a hidden feature of the future moment; and z_{k+T} represents a posterior feature of the future moment.

In some exemplary embodiments, a function f_{c} is used to represent a process of generating the bird's eye view of the environment, which is represented as the following formulas:

$$\{ \begin{matrix}{b}_{k} = fc ( {h}_{k} , {s}_{k} ) , historical moment \\ {b}_{k + T} = fc ( {h}_{k + T} , {z}_{k + T} ) , future moment\end{matrix} \qquad ( 5 )$$

wherein bₖ represents a bird's eye view of the historical moment; hₖ represents a hidden feature of the historical moment; sₖ represents a posterior feature of the historical moment; b_{k+T} represents a bird's eye view of the future moment; h_{k+T} represents a hidden feature of the future moment; and z_{k+T} represents a posterior feature of the future moment.

In some exemplary embodiments, the driving world model is a world model for model training; a process of the model training includes: taking data from a moment tₖ to a moment t_{k+T-1} as historical moment data, taking data from a moment t_{k+T} to a moment t_{k+T+F} as future moment data, inputting the data from tₖ to t_{k+T+F} to the driving world model for model training, so that a joint probability of an action sequence and an aerial view sequence is maximum, and obtaining a lower limit of the joint probability through variational inference.

In some exemplary embodiments, the lower limit of the joint probability obtained by the variational inference is as shown in the following formula:

$$log ( p ( {a}_{k : k + T + F} , {b}_{k : k + T + F} ) ) \geq {\sum }_{t = k}^{t = k + T + F} E [ log p ( {a}_{t} ) + log p ( {b}_{t} ) - {D}_{KL} ( q ( {s}_{k} ) , p ( {z}_{k} ) ) ] \qquad ( 6 )$$

wherein p(a_{k:k+T+F}, b_{k:k+T+F}) represents the joint probability of occurrence of an action sequence and an aerial view sequence; D_{KL} represents a relative entropy of the two distributions; p(aₜ) represents a probability of occurrence of the action sequence; p(bₜ) represents a probability of occurrence of the aerial view sequence; q(sₖ) represents a posterior probability in the world model; and (zₖ) represents a prior probability in the world model.

The technical solutions provided by the embodiments of the present application at least has the following advantages: The embodiments of the present application provide a driving world model based on a brain-like neural circuit. The model includes a perception module, an environment memory module, a brain-like neural circuit network module, and a convolutional network module, wherein the perception module is configured to perform image encoding on an input image by taking a monocular camera image as the input image and acquire an image feature under a view angle of an aerial view; the perception module includes a two-dimensional feature encoding unit, a three-dimensional feature encoding unit, and a summing pooling unit which are connected in sequence; the two-dimensional feature encoding unit is configured to extract two-dimensional features from the image feature; the three-dimensional feature encoding unit is configured to project the two-dimensional features to a three-dimensional space to obtain three-dimensional features and predicting a depth probability distribution of each three-dimensional feature; the summing pooling unit is configured to map the three-dimensional features to a bird's eye view space in a summing pooling manner according to the depth probability distributions to obtain the image feature under the view angle of the aerial view; the environment memory module is configured to: acquire and memorize environment dynamics information of a current moment according to the image feature and a hidden feature, and output the environment dynamics information to the brain-like neural circuit network module and the convolutional network module; the brain-like neural circuit network module is configured to: simulate a nematode neural network, establish a brain-like neural circuit network, and input the environment dynamics information to the brain-like neural circuit network to obtain a control output of automatic driving; and the convolutional network module is configured to input the environment dynamics information to a convolutional network to generate a bird's eye view of an environment.

The present application provides a driving world model based on a brain-like neural circuit, which takes the monocular camera image as the input, and obtains the two-dimensional features after the input image is encoded by the perception module; then promotes the two-dimensional features to a three-dimensional space to obtain the three-dimensional features; and predicts the depth probability distribution of each three-dimensional feature, and maps the three-dimensional features to a bird's eye view space in the summing pooling manner to obtain the image feature under a view angle of the aerial view. The present application can complete end-to-end automatic driving by only using a monocular camera as an input image. According to the present application, two-dimensional and three-dimensional information of an image can be fully extracted through the perception module, and an autonomous vehicle is helped to safely run under the view angle of the aerial view considering environment depth information. In addition, the present application also establishes the brain-like neural circuit network by simulating an operation process of a nematode neural network on perception, planning, and control, and obtains the control output of automatic driving. Meanwhile, bird's eye view of the environment are generated on the basis of the environment dynamics information, so that the interpretability of the model is improved. The model uses a monocular camera image as an input. The world model is applied to extracting and memorizing environment dynamics information, simulating a nematode nervous system to establish the brain-like neural circuit to process the environment dynamics information, and completing an end-to-end automatic driving task.

### BRIEF DESCRIPTION OF THE DRAWINGS

One or more embodiments are illustrated by images in corresponding drawings, and these exemplary explanations are not to be construed as limiting the embodiments. Unless expressly stated otherwise, the images in the accompanying drawings do not constitute a proportion limitation.

FIG. 1 is a schematic structural diagram of a driving world model based on a brain-like neural circuit according to an embodiment of the present application.

FIG. 2 is a framework diagram of a driving world model based on a brain-like neural circuit according to an embodiment of the present application.

FIG. 3 is a schematic framework diagram of a brain-like neural circuit network according to an embodiment of the present application.

FIG. 4 is a schematic diagram of an aerial view according to an embodiment of the present application.

### DETAILED DESCRIPTION

It can be seen from the background section, most of existing automatic driving models use a modularization method. The method requires a large amount of artificial engineering and involves manual annotation of a single module and cross-module configuration. A new environment and a new task need to be manually redesigned for algorithm upgrade, so that the method is poor in mobility and cannot adapt to development and requirements of the general artificial intelligence.

A current development situation shows that generative artificial intelligence has a potential of bringing a leap change to an automatic driving technology. With the continuous improvement of the emerging capability of generative large models with billions of parameters, it is foreseeable that a significant breakthrough in an automatic driving technical route can be achieved by means of the strong processing capability and the complex parameter structure of the generative artificial intelligence.

In order to solve the above technical problem, an embodiment of the present application provides a driving world model based on a brain-like neural circuit. The model includes a perception module, an environment memory module, a brain-like neural circuit network module, and a convolutional network module, wherein the perception module is configured to perform image encoding on an input image by taking a monocular camera image as the input image and acquire an image feature under a view angle of an aerial view; the perception module includes a two-dimensional feature encoding unit, a three-dimensional feature encoding unit, and a summing pooling unit which are connected in sequence; the two-dimensional feature encoding unit is configured to extract two-dimensional features from the image feature; the three-dimensional feature encoding unit is configured to project the two-dimensional features to a three-dimensional space to obtain three-dimensional features and predicting a depth probability distribution of each three-dimensional feature; the summing pooling unit is configured to map the three-dimensional features to a bird's eye view space in a summing pooling manner according to the depth probability distributions to obtain the image feature under the view angle of the aerial view; the environment memory module is configured to: acquire environment dynamics information of a current moment according to the image feature and a hidden feature, and output the environment dynamics information to the brain-like neural circuit network module and the convolutional network module; the brain-like neural circuit network module is configured to: simulate a nematode neural network, establish a brain-like neural circuit network, and input the environment dynamics information to the brain-like neural circuit network to obtain a control output of automatic driving; and the convolutional network module is configured to input the environment dynamics information to a convolutional network to generate a bird's eye view of an environment. The present application uses a monocular camera image as an input image. The world model is applied to extracting and memorizing environment dynamics information. Two-dimensional and three-dimensional information of an image can be fully extracted through the perception module, and a autonomous vehicle is helped to safely run under the view angle of the aerial view considering environment depth information. The model also simulates a nematode nervous system to establish the brain-like neural circuit to process the environment dynamics information and complete an end-to-end automatic driving task.

The respective embodiments of the present application will be described in detail below with reference to the accompanying drawings. However, those of ordinary skill in the art can understand that in the various embodiments of the present application, numerous technical details are set forth in order to enable readers to better understand the present application. However, the technical solutions claimed by the present application can also be implemented even without these technical details and the various changes and modifications based on the following embodiments.

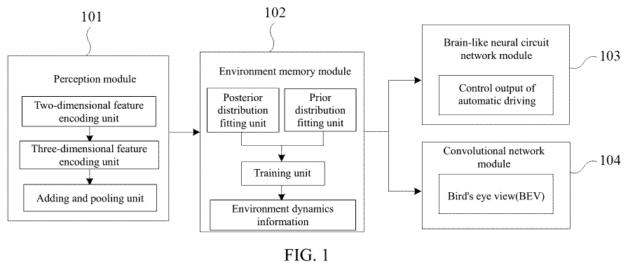

Referring to FIG. 1, the embodiments of the present application provide a driving world model based on a brain-like neural circuit. The driving world model includes: a perception module 101, an environment memory module 102, a brain-like neural circuit network module 103, and a convolutional network module 104, wherein the perception module 101 is configured to perform image encoding on an input image by taking a monocular camera image as the input image and acquire an image feature under a view angle of an aerial view; the perception module 101 includes a two-dimensional feature encoding unit, a three-dimensional feature encoding unit, and a summing pooling unit which are connected in sequence; the two-dimensional feature encoding unit is configured to extract two-dimensional features from the image feature; the three-dimensional feature encoding unit is configured to project the two-dimensional features to a three-dimensional space to obtain three-dimensional features and predicting a depth probability distribution of each three-dimensional feature; and the summing pooling unit is configured to map the three-dimensional features to a bird's eye view space in a summing pooling manner according to the depth probability distributions to obtain the image feature under the view angle of the aerial view.

The present application uses a monocular camera image as an input image. The world model is applied to extracting and memorizing environment dynamics information. By enhancing the perception part of the world model and simulating a nematode nervous system, the brain-like neural circuit is established to process the environment dynamics information and complete an end-to-end automatic driving task. A process for enhancing the perceptual part of the world model includes: taking a monocular camera image oₖ as an input image, first extracting 2D features of a surrounding environment through an image encoding module Resnet in the perception module, and performing image encoding. Since an autonomous vehicle needs to percept a three-dimensional environment, after the two-dimensional features are obtained in the present application, the two-dimensional features are projected into a 3D space through internal parameters and external parameters of a camera to obtain the three-dimensional features, and the depth probability distribution of each three-dimensional feature is predicted; and these three-dimensional features are processed in a summing pooling to obtain the image features under the view angle of the aerial view.

The environment memory module 102 is configured to: acquire environment dynamics information of a current moment according to the image feature and a hidden feature, and output the environment dynamics information to the brain-like neural circuit network module and the convolutional network module. The brain-like neural circuit network module 103 is configured to: simulate a nematode neural network, establish a brain-like neural circuit network, and input the environment dynamics information to the brain-like neural circuit network to obtain a control output of automatic driving; and the convolutional network module 104 is configured to input the environment dynamics information to a convolutional network to generate a bird's eye view of an environment.

Continuing to refer to FIG. 1, the environment memory module 102 includes a posterior distribution fitting unit, a prior distribution fitting unit, and a training unit, wherein the posterior distribution fitting unit is configured to fit an environment dynamics posterior distribution through the image feature; the prior distribution fitting unit is configured to fit an environment dynamics prior distribution through the hidden feature; and the training unit is configured to: perform training using a minimum difference between the environment dynamics posterior distribution and the environment dynamics prior distribution, obtain environment dynamics information of a current moment on the basis of the environment dynamics posterior distribution and the hidden feature, and generate a hidden feature of the current moment by using the environment dynamics information of the current moment as a hidden feature of a next moment.

In some embodiments, the environment memory module 102 acquires the environment dynamics information of the current moment by respectively generating a posterior feature and a prior feature according to the image feature and the hidden feature, wherein the posterior feature is generated by sampling a hidden feature containing historical moment information, an action of a previous moment, and the image feature; and the prior feature is generated by sampling the hidden feature containing the historical moment information and the action of the previous moment.

In some embodiments, memorized historical features include a posterior feature and a prior feature; the posterior feature is generated by sampling a hidden feature containing historical moment information, an action of a previous moment, and the image feature; and the prior feature is generated by sampling the hidden feature containing the historical moment information and the action of the previous moment.

In some embodiments, assuming that the posterior feature and the prior feature are both in accordance with a normal distribution, and generation processes of the posterior feature and the prior feature are expressed as:

$$\{ \begin{matrix}{x}_{k} = {f}_{e} ( {o}_{k} ) \\ q ( {s}_{k} ) ∼ N ( {μ}_{θ} ( {h}_{k} , {a}_{k - 1} , {x}_{k} ) , {σ}_{θ} ( {h}_{k} , {a}_{k - 1} , {x}_{k} ) ) \\ p ( {z}_{k} ) ∼ N ( {μ}_{φ} ( {h}_{k} , {a}_{k - 1} ) , {σ}_{φ} ( {h}_{k} , {a}_{k - 1} ) ) \\ {h}_{k + 1} = {f}_{ϕ} ( {h}_{k} , {s}_{k} )\end{matrix} \qquad ( 1 )$$

wherein xₖ represents the image feature; oₖ represents an input image; sₖ represents the posterior feature; zₖ represents the prior feature; hₖ represents the hidden feature; xₖ=fₑ(oₖ) represents a process of obtaining the image feature by taking an image at a moment k as an input; q(sₖ)˜N(μ_{θ}(hₖ, aₖ₋₁, xₖ), σ_{θ}(hₖ, aₖ₋₁, xₖ)) represents the generation process of the posterior feature; p(zₖ)˜N(μ_{φ}(hₖ, aₖ₋₁), σ_{θ}(hₖ, aₖ₋₁)) represents the generation process of the prior feature; aₖ₋₁ represents the action of the previous moment; and hₖ₊₁=f_{ϕ}(hₖ, sₖ) represents that the hidden feature of the next moment is obtained through a recurrent neural network.

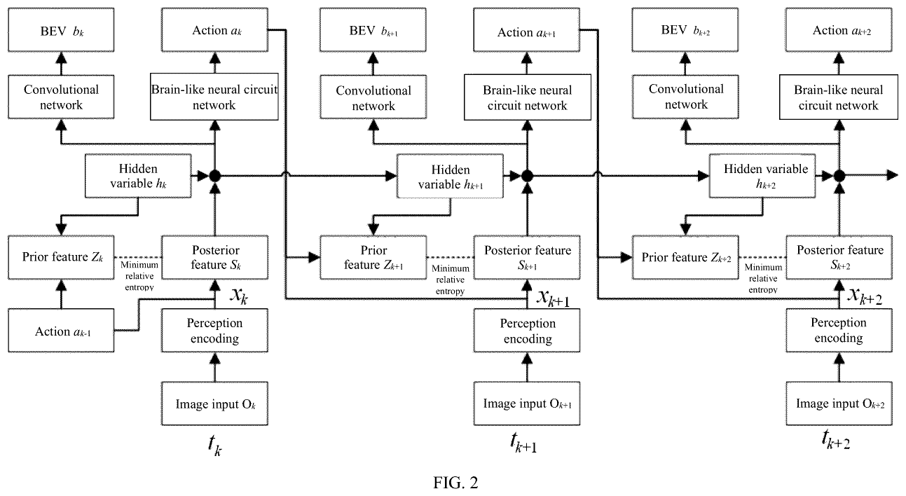

FIG. 2 is a framework diagram of a driving world model based on a brain-like neural circuit.

As shown in FIG. 2, an image oₖ at the moment k is used as an input image, and an image feature xₖ is obtained by perception encoding. This process can be expressed as xₖ=fₑ(oₖ). Assuming that a posterior feature and a prior feature are both in accordance with a normal distribution, the posterior feature sₖ is generated by sampling a hidden feature containing historical moment information, an action aₖ₋₁ (a transverse and longitudinal acceleration) of a previous moment, and the image feature xₖ. The prior feature is generated by sampling the hidden feature and the action aₖ₋₁ of the previous moment; and p(zₖ)˜N(μ_{φ}(hₖ, aₖ₋₁), o_{φ}(hₖ, aₖ₋₁)) a hidden variable of a next moment is encoded through a recurrent neural network.

The driving world model at a future moment k+T cannot obtain an image input, and the driving world model obtains a future action and an aerial view trend are obtained by imagination. Specifically, the driving world model will not generate a posterior feature at the future moment, but generates the hidden feature h_{k+T+1} of the next moment by directly using the hidden feature h_{k+T} and the prior feature z_{k+T}.

In some embodiments, at the future moment k+T, generation processes of the prior feature Z_{k+T} and the hidden feature h_{k+T+1} of the next moment are expressed as:

$$\{ \begin{matrix}p ( {z}_{k} ) \sim N ( {μ}_{φ} ( {h}_{k} , {a}_{k - 1} ) , {σ}_{φ} ( {h}_{k} , {a}_{k - 1} ) ) \\ {h}_{k + T + 1} = {f}_{ϕ} ( {h}_{k + T} , {z}_{k + T} )\end{matrix} \qquad ( 2 )$$

wherein p(zₖ)˜N(μ_{φ}(hₖ, aₖ₋₁), σ_{φ}(hₖ, aₖ₋₁)) represents the generation process of a prior feature of the future moment; aₖ₋₁ represents the action of the previous moment; h_{k+T} and z_{k+T} respectively represent a hidden feature and a prior feature of the future moment k+T; and h_{k+T+1}=f_{ϕ}(h_{k+T}, z_{k+T}) represents a process of generating the hidden feature of the next moment using the hidden feature h_{k+T} and the prior feature Z_{k+T} at the future moment k+T.

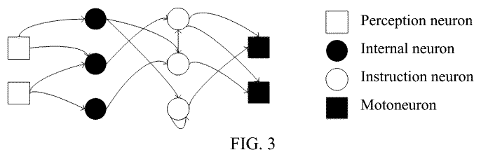

The present application establishes the brain-like neural circuit network by simulating the nematode nervous system. Caenorhabditis elegans is a very small animal, completing functions of perception, motion, and the like through its nearly perfect nervous system structure, and a plurality of neural circuits in the nervous system of the caenorhabditis elegans are modeled into a four-layer hybrid topological structure. The present application imitates the neural circuit of the caenorhabditis elegans and establishes a brain-like neural circuit network framework, as shown in FIG. 3.

Referring to FIG. 3, in some embodiments, the brain-like neural circuit network includes four layers of neurons, wherein the four layers of neurons respectively include: Nₛ perception neurons, Nᵢ internal neurons, N_{c} instruction neurons, and Nₘ motoneurons; nₛₒ₋ₜ synapses are inserted between any two successive layers for any source neuron, wherein nₛₒ₋ₜ satisfies nₛₒ₋ₜ≤Nₜ; Nₜ represents a quantity of target neurons; a synapse polarity satisfies the Bernoulli distribution, wherein nₛₒ₋ₜ target neurons are randomly selected through binomial distribution; mₛₒ₋ₜ synapses are inserted between any two consecutive layers for any target neuron j without synapses; mₛₒ₋ₜ satisfies

$${m}_{so - t} \leq \frac{1}{{N}_{t}} {Σ}_{i = 1 , i \neq j}^{{N}_{t}} {L}_{{t}_{i}} ,$$

wherein Lₜ_{ᵢ} represents a quantity of target neurons i inserted with the synapses; a synapse polarity satisfies the Bernoulli distribution, and mₛₒ₋ₜ source neurons are randomly selected through binomial distribution; the instruction neurons are cyclically connected; lₛₒ₋ₜ synapses are inserted into any instruction neuron, wherein lₛₒ₋ₜ satisfies lₛₒ₋ₜ≤N_{c}, wherein N_{c} represents a quantity of instruction neurons; a synaptic polarity satisfies the Bernoulli distribution; and lₛₒ₋ₜ source neurons are randomly selected through binomial distribution.

In some embodiments, each neuron is modeled as follows according to features of current transmission between the synapses of the neuron:

$$\frac{dx ( t )}{dt} = - \frac{x ( t )}{τ} + {f}_{I} ( I ( t ) ) ( A - x ( t ) ) \qquad ( 3 )$$

wherein x(t) represents a current of the synapse of the neuron; I(t) represents an external input of the synapse; A represents deviation matrix; fₗ represents a neural network; and τ represents a time constant.

As described above, the nematode neural network is simulated to establish the brain-like neural circuit network, so that the brain-like neural circuit network is regarded as a function g, and the brain-like neural circuit network is used to convert the environment dynamics information into control action information, so as to achieve the conversion process from perception to control.

In some embodiments, the brain-like neural circuit network module includes a conversion unit; the conversion unit is configured to convert the environment dynamics information into control action information by using the brain-like neural circuit network, so as to achieve a conversion process from perception to control; a function g is used to represent the brain-like neural circuit network, and the conversion process is expressed by the following formulas:

$$\{ \begin{matrix}{a}_{k} = g ( {h}_{k} , {s}_{k} ) , a historical moment \\ {a}_{k + T} = g ( {h}_{k + T} , {z}_{k + T} ) , future moment\end{matrix} \qquad ( 4 )$$

wherein aₖ represents an action of the historical moment; hₖ represents the hidden feature; sₖ represents the posterior feature; a_{k+T} represents an action of the future moment; h_{k+T} represents a hidden feature of the future moment; and z_{k+T} represents a posterior feature of the future moment.

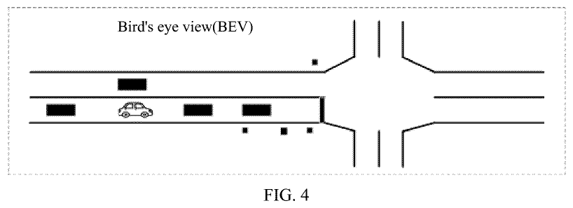

A bird's eye view bₖ is generated by using the environment dynamics information through the convolutional neural network, so that the interpretability of the end-to-end method can be improved. The aerial view is as shown in FIG. 4, and the process can be regarded as a function f_{c}.

Specifically, in some embodiments, a function f_{c} is used to represent a process of generating the bird's eye view of the environment, which is represented as the following formulas:

$$\{ \begin{matrix}{b}_{k} = fc ( {h}_{k} , {s}_{k} ) , historical moment \\ {b}_{k + T} = fc ( {h}_{k + T} , {z}_{k + T} ) , future moment\end{matrix} \qquad ( 5 )$$

wherein bₖ represents a bird's eye view of the historical moment; hₖ represents a hidden feature of the historical moment; sₖ represents a posterior feature of the historical moment; b_{k+T} represents a bird's eye view of the future moment; h_{k+T} represents a hidden feature of the future moment; and z_{k+T} represents a posterior feature of the future moment.

In some embodiments, the driving world model is a world model for model training.

A process of the model training includes: taking data from a moment tₖ to a moment t_{k+T-1} as historical moment data, taking data from a moment t_{k+T} to a moment t_{k+T+F} as future moment data, inputting the data from tₖ to t_{k+T+F} to the driving world model for model training, so that a joint probability of an action sequence and an aerial view sequence is maximum, and obtaining a lower limit of the joint probability through variational inference;

In some embodiments, the lower limit of the joint probability obtained by the variational inference is as shown in the following formula:

$$log ( p ( {a}_{k : k + T + F} , {b}_{k : k + T + F} ) ) \geq {\sum }_{t = k}^{t = k + T + F} E [ log p ( {a}_{t} ) + log p ( {b}_{t} ) - {D}_{KL} ( q ( {s}_{k} ) , p ( {z}_{k} ) ) ] \qquad ( 6 )$$

wherein p(a_{k:k+T+F}, b_{k:k+T+F}) represents the joint probability of occurrence of an action sequence and an aerial view sequence; D_{KL} represents a relative entropy of the two distributions; p(aₜ) represents a probability of occurrence of the action sequence; p(bₜ) represents a probability of occurrence of the aerial view sequence; q(sₖ) represents a posterior probability in the world model; and p(zₖ) represents a prior probability in the world model.

According to the above technical solutions, the embodiments of the present application provide a driving world model based on a brain-like neural circuit. The model includes a perception module, an environment memory module, a brain-like neural circuit network module, and a convolutional network module, wherein the perception module is configured to perform image encoding on an input image by taking a monocular camera image as the input image and acquire an image feature under a view angle of an aerial view; the perception module includes a two-dimensional feature encoding unit, a three-dimensional feature encoding unit, and a summing pooling unit which are connected in sequence; the two-dimensional feature encoding unit is configured to extract two-dimensional features from the image feature; the three-dimensional feature encoding unit is configured to project the two-dimensional features to a three-dimensional space to obtain three-dimensional features and predicting a depth probability distribution of each three-dimensional feature; the summing pooling unit is configured to map the three-dimensional features to a bird's eye view space in a summing pooling manner according to the depth probability distributions to obtain the image feature under the view angle of the aerial view; the environment memory module is configured to: acquire and memorize environment dynamics information of a current moment according to the image feature and a hidden feature, and output the environment dynamics information to the brain-like neural circuit network module and the convolutional network module; the brain-like neural circuit network module is configured to: simulate a nematode neural network, establish a brain-like neural circuit network, and input the environment dynamics information to the brain-like neural circuit network to obtain a control output of automatic driving; and the convolutional network module is configured to input the environment dynamics information to a convolutional network to generate a bird's eye view of an environment.

The present application provides a driving world model based on a brain-like neural circuit, which takes the monocular camera image as the input, and obtains the two-dimensional features after the input image is encoded by the perception module; then promotes the two-dimensional features to a three-dimensional space to obtain the three-dimensional features; and predicts the depth probability distribution of each three-dimensional feature, and maps the three-dimensional features to a bird's eye view space in the summing pooling manner to obtain the image feature under a view angle of the aerial view. The present application can complete end-to-end automatic driving by only using a monocular camera as an input image. According to the present application, two-dimensional and three-dimensional information of an image can be fully extracted through the perception module, and an autonomous vehicle is helped to safely run under the view angle of the aerial view considering environment depth information. In addition, the present application also establishes the brain-like neural circuit network by simulating an operation process of a nematode neural network on perception, planning, and control, and obtains the control output of automatic driving. Meanwhile, bird's eye view of the environment are generated on the basis of the environment dynamics information, so that the interpretability of the model is improved. The model uses a monocular camera image as an input. The world model is applied to extracting and memorizing environment dynamics information, simulating a nematode nervous system to establish the brain-like neural circuit to process the environment dynamics information, and completing an end-to-end automatic driving task.

Those of ordinary skill in the art can understand that the foregoing implementations are specific embodiments of practicing the present application, while in practical applications, various changes can be made to the implementations in form and detail without departing from the spirit and scope of the present application. Any person skilled in the art can make respective changes and modifications without departing from the spirit and scope of the present application, and the protection scope of the present application is defined by the appended claims.

What is claimed is:

1. A driving world model based on a brain-like neural circuit, comprising: a perception module, an environment memory module, a brain-like neural circuit network module, and a convolutional network module, wherein
the perception module is configured to take a monocular camera image as an input image and perform image encoding on the input image to acquire an image feature under a bird's-eye view; the perception module comprises a two-dimensional feature encoding unit, a three-dimensional feature encoding unit, and a summing pooling unit which are connected in sequence; the two-dimensional feature encoding unit is configured to extract two-dimensional features from the image feature; the three-dimensional feature encoding unit is configured to project the two-dimensional features to a three-dimensional space to obtain three-dimensional features and predict a depth probability distribution of each three-dimensional feature; the summing pooling unit is configured to map the three-dimensional features to a bird's eye view space in a summing pooling manner according to the depth probability distribution to obtain the image feature under the bird's-eye view;
the environment memory module is configured to acquire environment dynamics information of a current moment according to the image feature and a hidden feature, and output the environment dynamics information to the brain-like neural circuit network module and the convolutional network module;
the brain-like neural circuit network module is configured to simulate a nematode neural network to establish a brain-like neural circuit network, and input the environment dynamics information into the brain-like neural circuit network to obtain a control output of automatic driving;
the convolutional network module is configured to input the environment dynamics information into a convolutional network to generate a bird's eye view of the environment.

2. The driving world model based on a brain-like neural circuit according to claim 1, wherein the environment memory module comprises a posterior distribution fitting unit, a prior distribution fitting unit, and a training unit, wherein
the posterior distribution fitting unit is configured to fit environment dynamics posterior distribution through the image feature;
the prior distribution fitting unit is configured to fit environment dynamics prior distribution through the hidden feature;
the training unit is configured to perform training with a minimum difference between the environment dynamics posterior distribution and the environment dynamics prior distribution, obtain environment dynamics information of a current moment on the basis of the environment dynamics posterior distribution and the hidden feature, and generate a hidden feature of the current moment by using the environment dynamics information of the current moment as a hidden feature of a next moment.

3. The driving world model based on a brain-like neural circuit according to claim 1, wherein the environment memory module acquires the environment dynamics information of the current moment by respectively generating a posterior feature and a prior feature according to the image feature and the hidden feature, wherein
the posterior feature is generated by sampling a hidden feature containing historical moment information, an action of a previous moment, and the image feature;
the prior feature is generated by sampling the hidden feature containing the historical moment information and the action of the previous moment.

4. The driving world model based on a brain-like neural circuit according to claim 3, wherein assuming that the posterior feature and the prior feature are both in accordance with a normal distribution, and generation processes of the posterior feature and the prior feature are expressed as:
$$\{ \begin{matrix}\begin{matrix}\begin{matrix}{x}_{k} = {f}_{e} ( {o}_{k} ) \\ q ( {s}_{k} ) \sim N ( {μ}_{θ} ( {h}_{k} , {a}_{k - 1} , {x}_{k} ) , {σ}_{θ} ( {h}_{k} , {a}_{k - 1} , {x}_{k} ) )\end{matrix} \\ p ( {z}_{k} \sim N ( {μ}_{φ} ( {h}_{k} , {a}_{k - 1} ) , {σ}_{φ} ( {h}_{k} , {a}_{k - 1} ) )\end{matrix} \\ {h}_{k + 1} = {f}_{ϕ} ( {h}_{k} , {s}_{k} )\end{matrix} \qquad ( 1 )$$
wherein xₖ represents the image feature; oₖ represents the input image; sₖ represents the posterior feature; zₖ represents the prior feature; hₖ represents the hidden feature; xₖ=fₑ(oₖ) represents a process of obtaining the image feature by taking a monocular camera image at time k as an input; q(sₖ)˜N(μ₇₄ (hₖ, aₖ₋₁, xₖ), σ_{θ}(hₖ, aₖ₋₁, xₖ)) represents the generation process of the posterior feature; p(zₖ)˜N(μ_{φ}(hₖ, aₖ₋₁), σ_{φ}(hₖ, aₖ₋₁)) represents the generation process of the prior feature; aₖ₋₁ represents the action of the previous moment; and hₖ₊₁=f_{ϕ}(hₖ, sₖ) represents that the hidden feature of the next moment is obtained through a recurrent neural network.

5. The driving world model based on a brain-like neural circuit according to claim 1, wherein at a future moment, generation processes of the prior feature and the hidden feature of the next moment are expressed as:
$$\{ \begin{matrix}p ( {z}_{k} ) ∼ N ( {μ}_{φ} ( {h}_{k} , {a}_{k - 1} ) , {σ}_{φ} ( {h}_{k} , {a}_{k - 1} ) ) \\ {h}_{k + T + 1} = {f}_{ϕ} ( {h}_{k + T} , {z}_{k + T} )\end{matrix} \qquad ( 2 )$$
wherein p(zₖ)—N(μ_{φ}(hₖ, aₖ₋₁), σ_{φ}(hₖ, aₖ₋₁)) represents the generation process of the prior feature of the future moment; aₖ₋₁ represents the action of the previous moment; h_{k+T} and z_{k+T} respectively represent a hidden feature and a prior feature at a future moment k+T; and h_{k+T+1}=f_{ϕ}(h_{k+T}, z_{k+T}) represents a process of generating the hidden feature of the next moment using the hidden feature h_{k+T} and the prior feature z_{k+T} at the future moment k+T .

6. The driving world model based on a brain-like neural circuit according to claim 1, wherein the brain-like neural circuit network comprises four layers of neurons, wherein
the four layers of neurons include: Nₛ perception neurons, Nᵢ internal neurons, N_{c} instruction neurons, and Nₘ motoneurons;
nₛₒ₋ₜ synapses are inserted between any two consecutive layers for any source neuron, wherein nₛₒ₋ₜ satisfies the requirement of nₛₒ₋ₜ≤Nₜ, and a synapse polarity satisfies the Bernoulli distribution, wherein Nₜ represents a quantity of target neurons, and nₛₒ₋ₜ target neurons are randomly selected through binomial distribution;
mₛₒ₋ₜ synapses are inserted between any two consecutive layers for any target neuron j without synapses; mₛₒ₋ₜ satisfies the requirement of
$${m}_{so - t} \leq \frac{1}{{N}_{t}} {Σ}_{i = 1 , i \neq j}^{{N}_{t}} {L}_{{t}_{i}} ,$$
wherein Lₜ_{ᵢ} represents a quantity of target neurons i inserted with the synapses, a synapse polarity satisfies the Bernoulli distribution, and mₛₒ₋ₜ source neurons are randomly selected through binomial distribution;
the instruction neurons are cyclically connected; lₛₒ₋ₜ synapses are inserted into any instruction neuron, wherein lₛₒ₋ₜ satisfies the requirement of lₛₒ₋ₜ≤N_{c}; a synaptic polarity satisfies the Bernoulli distribution, wherein N_{c} represents a quantity of instruction neurons; and lₛₒ₋ₜ source neurons are randomly selected through binomial distribution.

7. The driving world model based on a brain-like neural circuit according to claim 6, wherein each neuron is modeled as follows according to features of current transmission between the synapses of the neuron:
$$\frac{d x ( t )}{dt} = - \frac{x ( t )}{τ} + {f}_{I} ( I ( t ) ) ( A - x ( t ) ) \qquad ( 3 )$$
wherein x(t) represents a current of the synapse of the neuron; I(t) represents an external input of the synapse; A represents a deviation matrix; fₗ represents a neural network; and τ represents a time constant.

8. The driving world model based on a brain-like neural circuit according to claim 1, wherein the brain-like neural circuit network module comprises a conversion unit;
the conversion unit is configured to convert the environment dynamics information into control action information by using the brain-like neural circuit network, so as to achieve a conversion process from perception to control;
function g is used to represent the brain-like neural circuit network, and the conversion process is expressed as follows:
$$\{ \begin{matrix}{a}_{k} = g ( {h}_{k} , {s}_{k} ) , historical moment \\ {a}_{k + T} = G ( {h}_{k + T} , {z}_{k + T} ) , future moment\end{matrix} \qquad ( 4 )$$
wherein aₖ represents an action of the historical moment; hₖ represents a hidden feature; sₖ represents a posterior feature; a_{k+T} represents an action of the future moment; h_{k+T} represents a hidden feature of the future moment; and z_{k+T} represents a posterior feature of the future moment.

9. The driving world model based on a brain-like neural circuit according to claim 1, wherein function f_{c} is used to represent a process of generating the bird's eye view of the environment, which is expressed as follows:
$$\{ \begin{matrix}{b}_{k} = fc ( {h}_{k} , {s}_{k} ) , historical moment \\ {b}_{k + T} = fc ( {h}_{k + T} , {z}_{k + T} ) , future moment\end{matrix} \qquad ( 5 )$$
wherein bₖ represents a bird's eye view of the historical moment; hₖ represents a hidden feature of the historical moment; sₖ represents a posterior feature of the historical moment; b_{k+T} represents a bird's eye view of the future moment; h_{k+T} represents a hidden feature of the future moment; and z_{k+T} represents a posterior feature of the future moment.

10. The driving world model based on a brain-like neural circuit according to claim 1, wherein the driving world model is a world model that has gone through a model training;
a process of the model training comprises: taking data from time tₖ to t_{k+T-1} as historical moment data, taking data from time t_{k+T} to t_{k+T+F} as future moment data, inputting the data from tₖ to t_{k+T+F} into the driving world model for model training to maximize a joint probability of occurrence of an action sequence and an aerial view sequence, and obtaining a lower limit of the joint probability through variational inference;
obtaining the lower limit of the joint probability through variational inference is expressed as follows:
$$log ( p ( {a}_{k : k + T + F} , {b}_{k : k + T + F} ) ) \geq {\sum }_{t = k}^{t = k + T + F} E [ log p ( {a}_{t} ) + log p ( {b}_{t} ) - {D}_{KL} ( q ( {s}_{k} ) , p ( {z}_{k} ) ) ] \qquad ( 6 )$$
wherein p(a_{k:k+T+F}, b_{k:k+T+F}) represents a joint probability of occurrence of an action sequence and an aerial view sequence; D_{KL} represents a relative entropy between two distributions; p(aₜ) represents a probability of occurrence of the action sequence; p(bₜ) represents a probability of occurrence of the aerial view sequence; q(sₖ) represents a posterior probability in the world model; and p(zₖ) represents a prior probability in the world model.
